(19) United States
(12) Patent Application Publication
(10) Pub. No.: US 2002/0065352 A1
(43) Pub. Date: May 30, 2002

(54) Drag-reducing polymers and suspensions thereof

(76) Inventors: Ray L. Johnston, Ponca City, OK (US); Stuart N. Milligan, Ponca City, OK (US); Kenneth W. Smith, Tonkawa, OK (US)

Correspondence Address: Michael G. Locklar, Baker Botts L.L.P., 910 Louisiana, One Shell Plaza, Houston, TX, 77002-4995, US

(21) Appl. No.: 09/912,875

(22) Filed: Jul. 25, 2001

Related U.S. Application Data
(63) Continuation-in-part of application No. 09/724,049, filed on Nov. 28, 2000.
(63) Continuation-in-part of application No. 09/724,163, filed on Nov. 28, 2000.
(63) Continuation-in-part of application No. 09/723,399, filed on Nov. 28, 2000.
(63) Continuation-in-part of application No. 09/723,571, filed on Nov. 28, 2000.

(51) Int. Cl. C08K 5/01

(52) U.S. Cl. 524/487; 524/570

(57) ABSTRACT

Hydrocarbon-soluble drag-reducing polymer mixtures and suspensions thereof are described, along with processes for manufacturing both drag-reducing polymer mixtures and suspensions. The drag-reducing polymer mixtures are easily transportable, non-hazardous, easily handled, provide excellent drag-reducing properties, and most, if not all, solids in the drag-reducing polymer mixtures and suspensions impart drag-reducing effects. The drag-reducing polymer mixtures are manufactured by mixing ultra-high molecular weight soft-polymer with ultra-high molecular weight hard-polymer and grinding them below the minimum glass transition temperature. Drag-reducing polymer suspensions may be produced by mixing the above-described drag-reducing polymer mixture with a suspending fluid.

### RELATED REFERENCES

This application is a continuation-in-part of application Ser. Nos. 09/724,049, 09/724,163, 09/723,399, and 09/723,571, all filed on Nov. 28, 2000.

### FIELD OF THE INVENTION

The present invention relates to drag-reducing polymers and suspensions therefrom and to methods of manufacturing drag-reducing polymers and suspensions therefrom. More specifically, this invention relates to a method for preparing ultra-high molecular weight hydrocarbon-soluble polymers and suspensions that are substantially free of non-drag-reducing solids.

### BACKGROUND OF THE INVENTION

A drag-reducing agent is one that substantially reduces the friction losses that result from the turbulent flow of a fluid. Where fluids are transported over long distances, such as in oil and other hydrocarbon liquid pipelines, these friction losses result in inefficiencies that increase equipment and operation costs. Ultra-high molecular weight polymers are known to function well as drag-reducing agents, particularly in hydrocarbon liquids. In general, drag reduction depends in part upon the molecular weight of the polymer additive and its ability to dissolve in the hydrocarbon under turbulent flow. Effective drag-reducing polymers typically have molecular weights in excess of five million.

Drag-reducing polymers are known in the art. Representative, but non-exhaustive, samples of such art are U.S. Pat. No. 3,692,675, which teaches a method for reducing friction loss or drag for pumpable fluids through pipelines by adding a minor amount of a high molecular weight, non-crystalline polymer, and U.S. Pat. No. 3,884,252, which teaches the use of polymer crumb as a drag-reducing material. These materials are extremely viscoelastic and, in general, have no known use other than as drag-reducing materials. However, the very properties that make these materials effective as drag-reducing additives make them difficult to handle due to a severe tendency to cold flow and agglomerate even at sub-ambient temperatures. Under conditions of pressure, such as stacking or palleting, cold flow is even more intense and agglomeration occurs very quickly.

The general propensity of non-crosslinked elastomeric polymers (elastomers) to cold flow and agglomerate is well known. Polymers of this sort cannot be pelletized or put into discrete form and then stored for any reasonable period of time without the materials flowing together to form large agglomerates. Because of such difficulties, elastomers are normally shipped and used as bales. However, expensive equipment is required to handle such bales. In addition, polymers such as the drag-reducing additives described above are not suitable for such baling, since cold flow is extremely severe. Further, unless delivered as very small particles, dissolution time for such drag-reducing materials from a bulk polymer state in the flowing hydrocarbons to a dissolved state is so lengthy as to severely reduce the effectiveness of this material as a drag-reducing substance.

Numerous attempts have been made to overcome the disadvantages inherent in cold-flowing polymers. Representative, but non-exhaustive, of such art is that described in U.S. Pat. No. 3,791,913, wherein elastomeric pellets are surface cured (i.e., vulcanized to a minor depth in order to maintain the unvulcanized interior of the polymer in a “sack” of cured material), and U.S. Pat. No. 4,147,677, describing a method of preparing a free-flowing, finely divided powder of neutralized sulfonated elastomer by admixing with fillers and oils. This reference does not teach a method for making free-flowing powders of non-elastomeric material. U.S. Pat. No. 3,736,288 teaches solutions of drag-reducing polymers in inert, normally liquid vehicles for addition to liquids flowing in conduits. Suspension or surface-active agents may also be used. While directed to ethylene oxide polymers, the method is useful for hydrocarbon-soluble polymers as well. U.S. Pat. No. 4,088,622 describes a method of making an improved, molded drag-reducing coating by incorporating antioxidants, lubricants, and plasticizers and wetting agents in the form of a coating which is bonded directly onto the surface of materials passing through a liquid medium. U.S. Pat. No. 4,340,076 teaches a process for dissolving ultra-high molecular weight hydrocarbon polymer and liquid hydrocarbons by chilling to cryogenic temperatures, comminuting the polymer into discrete particles, and contacting these materials at near cryogenic temperatures with the liquid hydrocarbons to more rapidly dissolve the polymer. U.S. Pat. No. 4,341,078 immobilizes toxic liquids within a container by injecting a slurry of cryogenically ground polymer particles while still at cryogenic temperatures into the toxic liquid. U.S. Pat. No. 4,420,440 teaches a method for collecting spilled hydrocarbons by dissolving sufficient polymer to form a non-flowing material of semisolid consistency by contacting said hydrocarbons with a slurry of cryogenically comminuted ground polymer particles while still at cryogenic temperatures.

Some current drag-reduction systems inject a drag-reducing polymer solution containing a high percentage of dissolved ultra-high molecular weight polymer into conduits containing the hydrocarbon. The drag-reducing polymer solution is normally extremely thick and difficult to handle at low temperatures. Depending upon the temperature of the hydrocarbon and the concentration at which the drag-reducing polymer solution is injected, significant time elapses before dissolution and resulting drag reduction. Drag reduction is greatly enhanced once dissolution finally occurs; however, complete become very viscous as polymer content increases, in some cases limiting the practical application of these solutions to those containing no more than about 15 weight percent polymer. This makes complex equipment necessary for storing, dissolving, pumping, and injecting metered quantities of drag-reducing material into flowing hydrocarbons.

Another way currently used to introduce ultra-high molecular weight polymers into the flowing hydrocarbon stream is through a suspension. To create a drag-reducing polymer suspension, ultra-high molecular weight polymers are suspended in a liquid that may be either aqueous or non-aqueous. This suspension is then introduced into the flowing hydrocarbon stream. Because ultra-high molecular weight polymer particles tend to agglomerate, manufacture of these suspensions may be difficult. A way of controlling the tendency of the ultra-high molecular weight polymers to agglomerate may be to partially surround the polymer particles with a partitioning agent that reduces the polymer's tendency to agglomerate. U.S. Pat. No. 4,584,244, which is hereby incorporated by reference, describes a process whereby the polymer is ground and then dusted with alumina to form a free-flowing powder. Some processes using a partitioning agent require that the partitioning agent completely surround the polymer core, which requires that at least 20% and often as much as 50% of the weight of the final composition be the coating agent. Other examples of partitioning agents used in the art include talc, tri-calcium phosphate, magnesium stearate, silica, polyanhydride polymers, sterically hindered alkyl phenol antioxidants, and graphite. Partitioning agents, however, add weight to the drag-reducing agent material, resulting in higher transport costs and additional handling equipment, without any drag-reducing benefit. Further, some partitioning agents are incompatible with the hydrocarbon fluid or may be an unwanted contaminant of the hydrocarbon fluid.

### SUMMARY OF THE INVENTION

Accordingly, drag-reducing polymer mixtures and suspension therefrom and methods of producing drag-reducing polymer mixtures and suspensions therefrom are disclosed herein. One embodiment of the present invention is drawn to a method for the preparation of a drag-reducing polymer wherein ultra-high molecular weight soft-polymer is ground with ultra-high molecular weight hard-polymer at or below the minimum glass transition temperature to form a small-size soft-polymer/hard-polymer particles with drag-reducing qualities. In another embodiment of the present invention, hard-polymer is ground to particulate form without the use of partitioning agent after which soft-polymer is ground in the presence of the hard-polymer particles without a partitioning agent. In yet another embodiment of the present invention, the small-size soft-polymer/hard-polymer particles are mixed with a suspending fluid, which may be either aqueous or non-aqueous, to form a drag-reducing polymer suspension. In still another embodiment of the present invention a drag-reducing polymer comprised of ultra-high molecular weight soft-polymer and ultra-high molecular weight hard-polymer with no added partitioning agent is provided. Yet another embodiment describes a drag-reducing polymer suspension comprised of ultra-high molecular weight soft-polymer, ultra-high molecular weight hardpolymer, and suspending fluid.

One advantage of the present invention is that the drag-reducing polymers and suspensions thereof are easily transported and do not require special equipment for storage, transport, or injection. Another advantage is that the drag-reducing soft-polymer is quickly dissolved in the flowing hydrocarbon stream, while the hard-polymer may dissolve at a relatively slower rate than the soft-polymer. Such a disparity in dissolution rates creates a two-punch drag-reducing benefit wherein the earlier-dissolving polymer yields instantaneous drag reduction and the later-dissolving polymer provides drag reduction further down the pipeline. A further advantage of the present invention is that the amount of non-drag-reducing solids in the final product may be greatly reduced or eliminated. Another advantage of the present invention is that the extra bulk and cost associated with transporting the non-drag-reducing solids may be eliminated, allowing easier and more cost-effective transport. Still another advantage of the present invention is that the tendency towards agglomeration of the drag-reducing polymer mixture is greatly reduced, allowing for easier handling during manufacture. Another advantage of the present invention is that the drag-reducing polymer suspension is stable, allowing a longer shelf life and balancing of customer demand with manufacturing time. In addition, manufacturing throughput is increased by the use of the hard-polymer in conjunction with the soft-polymer.

### DESCRIPTION OF THE DRAWINGS

FIG. 1 is a schematic of one embodiment of an apparatus for manufacturing the drag-reducing polymer suspension of the present invention.

### DETAILED DESCRIPTION OF THE INVENTION

In the present invention, ultra-high molecular weight drag-reducing soft-polymers are ground with ultra-high molecular weight drag-reducing hard-polymers at temperatures below the minimum glass transition temperature. “Minimum glass transition temperature” is the lowest glass transition temperature of any polymer in the mixture being ground. This ground soft-polymer/hard-polymer mixture may then be added to a suspending fluid to form a drag-reducing polymer suspension.

An ultra-high molecular weight drag-reducing polymer typically has a molecular weight of greater than 1 million, preferably more than 5 million. Glass transition temperatures vary, typically ranging from about −10° C. to about −100° C. (about 14° F. to about −148° F.) depending on the particular polymer at issue. The successful grinding of an ultra-high molecular weight drag-reducing polymer or mixtures of such polymers must generally occur at a temperature below the minimum glass transition temperature.

Ultra-high molecular weight drag-reducing polymers may be either soft-polymers or hard-polymers. A soft-polymer is a polymer that, at about 20° C., tends to cold flow, has a tacky consistency, and tends to agglomerate. For example, homopolymers formed from monomers of about 4 to about 10 carbon atoms are generally soft-polymers; soft-polymers may also be copolymers that exhibit the tacky consistency and agglomeration and coldflow tendencies described above. Generally, soft-polymers are not able to be successfully ground into a fine, manageable powder without the addition of a material that reduces the polymer's tendency to agglomerate.

Examples of soft-polymers include, but are not limited to, poly(alpha-olefin) homopolymers such as poly(1-butene), poly(1-hexene), poly(1-octene), poly(1-decene), and other homopolymers formed from monomers having carbon chain lengths of about 4 to about 10 carbons. Soft-polymers may also be a copolymers, (i.e., polymers composed of at least two types of monomers), as long as all of the monomers used have a carbon chain length of about 4 to about 12 carbons. Mixtures of one or more homopolymers with one or more copolymers may also be used in embodiments of the present invention. Other polymers of a generally similar nature that are soluble in the liquid hydrocarbon will also function in the invention.

In contrast, hard-polymers have a nearly crystalline structure and are neither soft nor tacky at temperatures near 20° C. Hard-polymers exhibit greatly reduced cold flow and agglomeration tendencies as compared to soft-polymers. A hard-polymer is typically formed from monomers of carbon chain lengths of about 12 carbon atoms and above. For example, homopolymers formed from monomers of a length of about 14 carbon atoms and above are generally hard-polymers; hard-polymers may also be copolymers that exhibit the physical characteristics described above. Hard-polymers may be ground into a fine, manageable powder suitable for use as a drag-reducing polymer without the need for a partitioning agent.

Examples of hard-polymers include, but are not limited to, poly(alpha-olefin) homopolymers such as poly(1-dodecene), poly(1-tetradecene), other homopolymers formed from monomers having carbon chain lengths of about 12 carbon atoms and above and mixtures thereof. Preferred homopolyrner-type hard-polymers are composed of monomers having lengths of about 14 carbon atoms and above. Ultra-high molecular weight hard-polymers may also be copolymers so long as the desired physical characteristics, as described above, are obtained. The addition of styrene monomer, 3-methylstyrene or 4-methylstyrene, 4-t-butyl-styrene, or other styrene-based monomers, such as vinyl toluenes, to the monomer mixture used to produce a copolymer will generally result in the formation of a hard-polymer. Mixtures of one or more homopolymers with one or more copolymers may also be used in embodiments of the present invention. Other polymers of a generally similar nature that are soluble in the liquid hydrocarbon will also finction in the invention.

Choice of a particular hard-polymer may be tailored to suit various applications. For crude oil pipelines or pipelines with intermediate shear points, hard-polymers with particularly high molecular weights, and correspondingly high dissolution times, may be chosen. hi drag-reducing applications associated with refined product pipelines, a lower molecular weight hard-polymer, with a more rapid dissolution rate, may be utilized to avoid detrimental viscosity effects at the refined pipeline filters. Hard-polymers with a styrene component are especially preferred in refined product pipeline applications, as they dissolve quickly and completely in flowing hydrocarbon streams.

By grinding soft-polymer with hard-polymer, the manufacturer may reduce or eliminate the need for partitioning agents normally required for soft-polymer grinding. Partitioning agents are solids that do not impart a drag-reducing effect added to the soft-polymer to prevent agglomeration during and after the grinding process. In the embodiments of this invention, hard-polymer may be used in lieu of or in conjunction with partitioning agent to retard agglomeration of the soft-polymer.

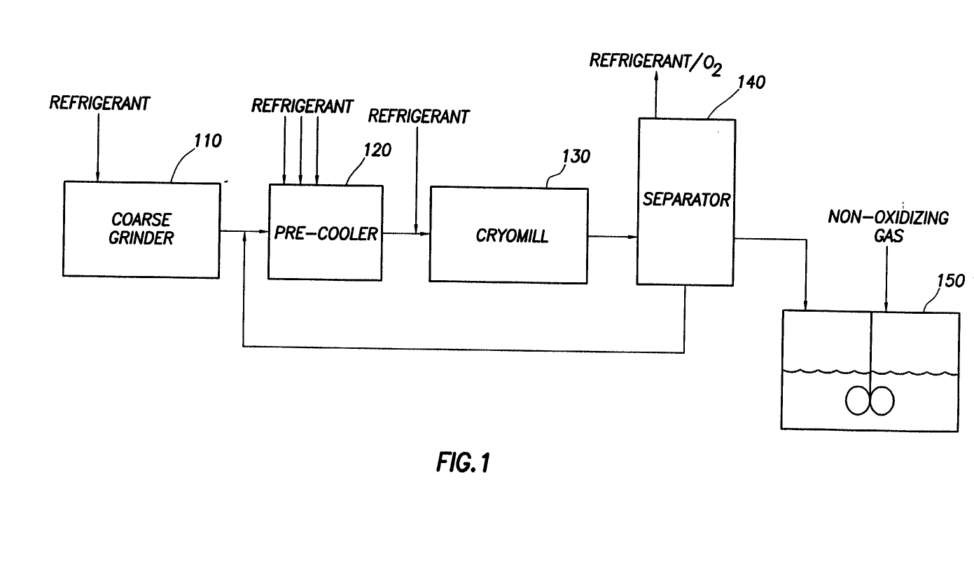

In one embodiment of the present invention, shown in FIG. 1, large chunks of ultra-high molecular weight soft-polymer and ultra-high molecular weight hard-polymer are initially conveyed to coarse grinder 110. While the ratio of hard-polymer to soft-polymer may be adjusted to suit an individual manufacturer's needs, the amount of hard-polymer used is typically from about 5% to about 50% by weight of the total weight of the soft-polymer/hard-polymer mixture; preferably from about 7% to about 40% by weight; most preferably from about 10% to about 30% by weight.

Coarse grinder 110 chops large polymer chunks into small polymer pieces, typically less than about 2 centimeters (about ¾ inch) in diameter. While coarse grinder 110 may be operated at ambient temperatures, it is preferable to cool the polymer in coarse grinder 110 from about 5° C. to about 15° C. (about 41° F. to about 59° F). The polymer in coarse grinder 110 may be cooled either internally, externally, or both. Such cooling may be accomplished via a liquid gaseous refrigerant, solid refrigerant, or combination thereof. In one embodiment, cooling is accomplished by spraying a liquid refrigerant, such as liquid nitrogen, liquid helium, liquid argon, or mixtures of two or more such refrigerants, into coarse grinder 110. In another embodiment, cooling is accomplished by mixing the ultra-high molecular weight polymer with a solid refrigerant such as dry ice (frozen carbon dioxide) or ice (frozen water).

Use of a partitioning agent with this invention is preferably avoided. However, a small amount, typically less than about 5% by weight of the total mixture, preferably less than about 4%, and most preferably less than about 3%, of a partitioning agent may be used in coarse grinder 110 in order to prevent agglomeration of the small soft-polymer pieces.

The small soft-polymer/hard-polymer pieces formed in coarse grinder 110 are then transported to pre-cooler 120. This transport may be accomplished by any number of typical solids-handling methods but is preferably accomplished via an auger or a pneumatic transport system. Pre-cooler 120 may be an enclosed screw conveyor with nozzles for spraying a liquid refrigerant, such as liquid nitrogen, helium, argon, or mixtures thereof, onto the small soft-polymer/hard-polymer pieces. Gaseous refrigerants may also be used; however, cooling efficiency is often too low to allow for the use of a gaseous refrigerant alone.

Use of a grinding aid is also preferably avoided; however, a grinding aid may be added to the small soft-polymer/hard-polymer pieces prior to cooling in pre-cooler 120. If the small soft-polymer/hard-polymer pieces will eventually be combined with a suspending fluid, the grinding aid should be a material that is totally soluble in that fluid. Moreover, if such solids are in liquid form at ambient temperatures, they must not be a solvent for the ultra-high molecular weight polymer and should not be a contaminant or be incompatible with the hydrocarbon liquid or mixture for which drag reduction is desired. The grinding aid particles may be of any shape but are typically crushed or in the form of pellets or cubes.

Pre-cooler 120 reduces the temperature of the small soft-polymer/hard-polymer pieces to a temperature below the minimum glass transition temperature. The target temperature is preferably below about −130° C. (about −202° F.), and most preferably below about −150° C. (about −238° F.). These temperatures may be produced by any known method. In a preferred embodiment, liquid refrigerant such as liquid nitrogen, liquid helium, liquid argon, or a mixture of two or more such refrigerants is sprayed directly onto the small soft-polymer/hard-polymer pieces. The rate of addition of the liquid refrigerant may be adjusted to maintain the polymer within the preferred temperature range.

After the small soft-polymer/hard-polymer pieces are cooled in pre-cooler 120, they are transported to cryomill 130. Again, this transport may be accomplished by any typical solids-handling method, preferably via an auger or a pneumatic transport system. A liquid refrigerant may be added to cryomill 130 in order to maintain the temperature of the small soft-polymer/hard-polymer pieces below their minimum glass transition temperature. It is preferable to maintain the temperature of the cryomill from about −130° C. to about 155° C. (about −202° F. to about −247° F.). Cryomill 130 may be any of the types of cryomills known in the art, such as a hammermill or an attrition cryomill. In cryomill 130, the small soft-polymer/hard-polymer pieces are ground to form small-size soft-polymer/hard-polymer particles having diameters from about 10 to about 800 microns. Generally, no partitioning agent is added in cryomill 130 in the method of this invention; however, hard-polymer that has previously been ground into small-size hard-polymer particles may be added to retard agglomeration. The particles may be transported to storage for later use, subjected to separation in separator 140, combined with a suspending fluid, or used immediately.

The small-size soft-polymer/hard-polymer particles exiting cryomill 130 (typically having diameters from about 10 to about 800 microns) may then be transferred to separator 140 if the larger particles are undesirable. Again, this transport may be accomplished by any typical solids handling method, preferably via an auger or a pneumatic transport system. Separator 140 acts to separate the larger polymer pieces from the smaller polymer pieces. Separator 140 may be any known type of separator suitable for separating particles, including a rotating sieve, a vibrating sieve, a centrifugal sifter, or a cyclone separator. Separator 140 vents a portion of the primarily vaporized refrigerant from cryomill 130. The primary function of separator 140 is to separate the small size polymer particles into a first fraction of particles having diameters below a set maximum diameter, from a second fraction of particles having a diameter above the set maximum diameter. The second fraction of particles may be discarded or, preferably, recycled to the pre-cooler 120 for regrinding. The set maximum diameter may vary depending on the separator, operating conditions, and desired end use. The set maximum diameter may range anywhere from about 100 microns to about 1000 microns, preferably from about 300 microns to about 800 microns, more preferably from about 400 microns to about 600 microns.

In an alternate embodiment of the method of the present invention, hard-polymer alone (without soft-polymer) is first processed as described above through coarse grinder 110, pre-cooler 120, cryomill 130 and, if desired, separator 140 to form small-size hard-polymer particles. The resulting small-size hard-polymer particles are then used in the processing, as described above, of the soft-polymer through coarse grinder 110, pre-cooler 120, cryomill 130 and, if desired, separator 140 to retard agglomeration. Essentially the pre-processed small-size hard-polymer particles act to retard agglomeration of the soft-polymer as they are ground to small-size particles. The small-size hard-polymer particles may be added to the soft-polymer in coarse grinder 110 and in cryomill 130, or as necessary to prevent agglomeration of the soft-polymer and to create small-size soft-polymer/hard-polymer particles. As above, the amount of hard-polymer used in this alternate embodiment is typically from about 5% to about 50% by weight of the total weight of the soft-polymer/hard-polymer mixture; preferably from about 7% to about 40% by weight; most preferably from about 10% to about 30% by weight.

The hard-polymer/soft-polymer particles may be transported and used for drag reduction. Alternatively, if a drag-reducing suspension is desired, the drag-reducing small-size soft-polymer/hard-polymer particles exiting cryomill 130 (or separator 140, if separation is employed) may be mixed with a suspending fluid in mix tank 150 to form a drag-reducing suspension comprised of suspending fluid and small-size soft-polymer/hard-polymer particles. Mix tank 150 acts to form a suspension of the polymer particles in the suspending fluid and may be any type of vessel designed to agitate the mixture to achieve uniform composition of the drag-reducing suspension, preferably a stirred tank. To reduce the hazard of fire or explosion resulting from the interaction between the small polymer particles, mix tank 150 may be blanketed with a non-oxidizing gas, such as nitrogen, argon, neon, carbon dioxide, carbon monoxide, or other similar gases. Such non-oxidizing gas may also be sparged into mix tank 150 during polymer particle addition. The suspending fluid may be aqueous or non-aqueous.

An aqueous suspending fluid may be any single-phase liquid in which water is the predominant component and is a non-solvent for the ultra-high molecular weight polymer. Water alone is the most commonly used suspending fluid. Highly polar solvents such as acetone, methylethyl ketone, dimethyl formamide, tetrahydrofuran, sulfolane, N-methyl pyrollidone, and lower carbon number alcohols such as methanol, ethanol, or their mixtures, may be used in combination with water as the suspending fluid.

Non-aqueous suspending fluids are preferred in finished product pipeline applications that cannot tolerate high levels of aqueous contaminants. A non-aqueous suspending fluid may be, for instance, a linear or branched alcohol, alone or in combination with a glycol. A preferred suspending fluid is comprised of mainly branched alcohols. In general, alcohols up to about 14 carbon atoms and polyethylene glycols of up to about 14 carbon atoms may be used. However, a more preferred combination is alcohols containing up to about 10 carbon atoms and polyethylene glycols containing up to about 10 carbon atoms. A most preferred suspending agent contains alcohols containing up to about 8 carbon atoms and polyethylene glycols containing up to about 8 carbon atoms. In some embodiments, suspensions may also be made with di(propylene glycol) methyl ether, tri(propylene glycol) methyl ether, tetrapropylene glycol methyl ether, ethyl glycol ethers, ethyl ethers of similar nature, or mixtures thereof. Those skilled in the art understand that mixtures of these various alcohols, glycols, and ethers may be used to provide a “tailored” suspending medium for the particular polyolefin loading and service conditions. A particular mixture may vary depending upon basic concepts such as price, convenience, or availability, as well as technical questions of stability, solubility, long-term storage, and compatibility with the flowing hydrocarbon. In a preferred mode, alcohol is combined with glycol to prepare a suspending medium of the proper density. When mixtures of alcohol and glycol are used to form the suspending fluid, they are generally combined at an alcohol:glycol ratio ranging from about 100:0 to about 1:1; however, the ratio is not critical and may be varied as necessary. In general, alcohols having densities that are near the density of high molecular weight polymer being used to impart drag reduction are preferred. As those of skill in the art will appreciate, other non-aqueous suspending fluids may be used depending on the use desired.

Other components may be added to mix tank 150 before, during, or after mixing the ground polymer particles with the suspending fluid in order to aid the formation of the suspension and/or to maintain the suspension. For aqueous suspensions, glycols, such as ethylene glycol or propylene glycol, may be added for freeze protection or as a density-balancing agent. The amount of glycol added may range from about 10% to about 60% of the suspending fluid, as needed. Use of solid components is preferably avoided; however, a suspension stabilizer may be used to aid in maintaining the suspension of the ultra-high molecular weight particles. Typical suspension stabilizers include talc, tri-calcium phosphate, magnesium stearate, silica, polyanhydride polymers, sterically hindered alkyl phenol antioxidants, and graphite. The total amount of suspension stabilizer added may range from 0% to about 40% of the suspending fluid; use of suspension stabilizer is preferably minimized in order to limit the total amount of non-drag-reducing solids present in the final drag-reducing suspension. A wetting agent, such as a surfactant may be added to aid in the dispersal of the polymer particles to form a uniform mixture. Non-ionic surfactants, such as linear secondary alcohol ethoxylates, linear alcohol ethoxylates, alkylphenol ethoxylates, and anionic surfactants, such as alkyl benzene sulfonates and alcohol ethoxylate sulfates, (e.g., sodium lauryl sulfate), are preferred. One example of a suitable surfactant is Tergitol 15-S-7, a nonionic alcohol ethoxylate surfactant made by Union Carbide. The amount of wetting agent added may range from about 0.01% to about 1% by weight of the suspending fluid but is preferably from about 0.01% to about 0.1%. In order to prevent foaming of the drag-reducing suspension during agitation, a suitable antifoaming agent may be used, typically a silicon- or oil-based antifoam. Generally, no more than 1% of the suspending fluid by weight of the active antifoaming agent is used. Representative but non-exhaustive examples of antifoaming agents are the trademark of, and sold by, Dow Corning, Midland, Mich., and Bubble Breaker products, trademark of, and sold by, Witco Chemical Company, Organics Division. After the small-size soft-polymer/hard-polymer particles and suspending fluid are agitated to form a uniform mixture, a thickening agent may be added to increase the viscosity of the mixture. Increasing the viscosity of the fluid retards separation of the suspension. Typical thickening agents are high molecular weight water-soluble polymers, examples of which include polysaccharides, polyacrylamides, xanthum gum, carboxymethyl cellulose, hydroxypropyl guar, hydroxyethyl cellulose, hydroxymethyl cellulose, and hydroxypropyl cellulose. Where water is the suspending fluid, the pH of the suspending fluid should be basic, preferably above about nine, to inhibit the growth of microorganisms.

The product resulting from the agitation in mix tank 150 is a stable suspension of a drag-reducing polymer in a suspending fluid suitable for use as a drag-reducing agent. This suspension may be transported to storage for later use, or it may be used immediately.

The liquid refrigerant, as well as the suspending fluid, partitioning agent, detergent, antifoaming agent, and thickener, should be combined in effective amounts to accomplish the results desired and to avoid hazardous operating conditions. These amounts will vary depending on individual process conditions and may be determined by one of ordinary skill in the art. The methods of the present invention do not require an inert atmosphere; however, the atmosphere should be controlled such that the risk of fire and explosion is minimized.

Where temperatures and pressures are indicated, those given are a guide to the most reasonable and best conditions presently known for those processes, but temperatures and pressures outside of those ranges may be used within the scope of this invention. The range of values expressed as between two values is intended to include the value stated in the range.

### EXAMPLE

A hard-polymer (a co-polymer formed from styrene and tetra-decene) was initially coarse-ground to produce small hard-polymer pieces. Those small hard-polymer pieces were then cryoground in the absence of partitioning agent to produce 578 grams of small-size hard-polymer particles. Next, soft-polymer (a poly(1-decene) homopolymer) was coarse-ground to produce 1349 grams of small soft-polymer pieces. The 1349 grams of small soft-polymer pieces were then successfully cryoground with the 578 grams of small-size hard-polymer particles in the absence of any additional partitioning agent to produce 1629 grams of small-size hard-polymer/soft-polymer particles. Two suspensions were formed from the small-size hard-polymer/soft-polymer particles, the first contained:

2768 grams of de-ionized water

496 grams of antifoam

80 grams of Tergitol 15-S-7 surfactant

99.5 grams of the small-size hard-polymer/soft-polymer particles

819 grams of liquid HEC (hydroxyethyl cellulose)

The second suspension contained:

2763 grams of de-ionized water

400 grams of antifoam

80 grams of Tergitol 15-S-7 surfactant

2020 grams of calcium stearate

777 grams of the small-size hard-polymer/soft-polymer particles

824 grams of liquid HEC (hydroxyethyl cellulose)

The present invention, therefore, is well adapted to carry out the objects and attain both the ends and the advantages mentioned, as well as other benefits inherent therein. While the present invention has been depicted, described, and is defined by reference to particular embodiments of the invention, such references do not imply a limitation to the invention, and no such limitation is to be inferred. The invention is capable of considerable modification, alternation, alteration, and equivalents in form and/or functions, as will occur to those of ordinary skill in the pertinent arts. The depicted and described embodiments of the invention are exemplary only, and are not exhaustive of the scope of the present invention. Consequently, the present invention is intended to be limited only by the spirit and scope of the appended claims, giving full cognizance to equivalents in all respects.

What is claimed is:

1. A method for the preparation of a drag-reducing polymer comprising:
grinding ultra-high molecular weight hard-polymer and ultra-high molecular weight soft-polymer at a temperature below the minimum glass-transition temperature to form the drag-reducing polymer.

2. The method as described in claim 1, wherein the ultra-high molecular weight soft-polymer and the ultra-high molecular weight hard-polymer are ground in the absence of partitioning agent.

3. The method as described in claim 1, wherein the ultra-high molecular weight soft-polymer and the ultra-high molecular weight hard-polymer are ground with less than about 5% partitioning agent by weight of the total mixture.

4. The method as described in claim 1, wherein the ultra-high molecular weight soft-polymer is a poly(alpha-olefin) homopolymer prepared from monomer with carbon chain lengths of about 4 to about 10 carbon atoms, a copolymer prepared from monomers of carbon chain lengths of about 4 to about 12 carbon atoms, or mixtures thereof.

5. The method as described in claim 1, wherein the ultra-high molecular weight hard-polymer is a poly(alpha-olefin) homopolymer prepared from monomer with carbon chain lengths of about 14 carbon atoms or more, a copolymer prepared from monomers with a carbon chain lengths of about 12 carbon atoms or more, a copolymer of styrene with monomer having a carbon chain lengths of about 12 carbon atoms or more, a copolymer of 3-methylstyrene or 4-methylstyrene or mixtures thereof with monomer having a carbon chain lengths of about 12 carbon atoms or more, a copolymer of 4-t-butyl-styrene with monomer having a carbon chain lengths of about 12 carbon atoms or more, or mixtures thereof.

6. The method as described in claim 1, wherein from about 5% to about 50% of the total weight of the drag-reducing polymer comprises ultra-high molecular weight hard-polymer.

7. A method for the preparation of a drag-reducing polymer suspension comprising:
(a) grinding ultra-high molecular weight hard-polymer and ultra-high molecular weight soft-polymer at a temperature below the lowest glass-transition temperature to form small-size soft-polymer/hard-polymer particles; and,
(b) mixing the small-size soft-polymer/hard-polymer particles with a suspending fluid to form the drag-reducing polymer suspension.

8. The method as described in claim 7, wherein the ultra-high molecular weight soft-polymer and the ultra-high molecular weight hard-polymer are ground in the absence of partitioning agent.

9. The method as described in claim 7, wherein the ultra-high molecular weight soft-polymer and the ultra-high molecular weight hard-polymer are ground with less than about 5% partitioning agent by weight of the total mixture.

10. The method as described in claim 7, wherein the suspending fluid comprises water.

11. The method as described in claim 7, wherein the suspending fluid is non-aqueous.

12. The method as described in claim 11, wherein the non-aqueous suspending fluid is a linear alcohol, a branched alcohol, an alcohol in combination with polyethylene glycol containing up to 14 carbon atoms, di(propylene glycol) methyl ether, tri(propylene glycol) methyl ether, tetra(propylene glycol) methyl ether, ethyl glycol ethers, or mixtures thereof.

13. The method as described in claim 7, wherein the ultra-high molecular weight soft-polymer is a poly(alpha-olefin) homopolymer prepared from monomer with carbon chain lengths of about 4 to about 10 carbon atoms, a copolymer prepared from monomers of carbon chain lengths of about 4 to about 12 carbon atoms, or mixtures thereof.

14. The method as described in claim 7, wherein the ultra-high molecular weight hard-polymer is a poly(alpha-olefin) homopolymer prepared from monomer with carbon chain lengths of about 14 carbon atoms or more, a copolymer prepared from monomers with a carbon chain lengths of about 12 carbon atoms or more, a copolymer of styrene with monomer having a carbon chain lengths of about 12 carbon atoms or more, a copolymer of 3-methylstyrene or 4-methylstyrene or mixtures thereof with monomer having a carbon chain lengths of about 12 carbon atoms or more, a copolymer of 4-t-butyl-styrene with monomer having a carbon chain lengths of about 12 carbon atoms or more, or mixtures thereof.

15. The method as described in claim 7, wherein from about 5% to about 50% of the total weight of the soft-polymer/hard-polymer particles comprises ultra-high molecular weight hard-polymer.

16. A drag-reducing polymer comprising:
(a) ultra-high molecular weight small-size soft-polymer particles; and
(b) ultra-high molecular weight small-size hard-polymer particles;
wherein the drag-reducing polymer contains no partitioning agent.

17. The drag-reducing polymer described in claim 16, wherein the ultrahigh molecular weight soft-polymer is a poly(alpha-olefin) homopolymer prepared from monomer with carbon chain lengths of about 4 to about 10 carbon atoms, a copolymer prepared from monomers of carbon chain lengths of about 4 to about 12 carbon atoms, or mixtures thereof.

18. The drag-reducing polymer described in claim 16, wherein the ultra-high molecular weight hard-polymer is a poly(alpha-olefin) homopolymer prepared from monomer with carbon chain lengths of about 14 carbon atoms or more, a copolymer prepared from monomers with a carbon chain lengths of about 12 carbon atoms or more, a copolymer of styrene with monomer having a carbon chain lengths of about 12 carbon atoms or more, a copolymer of 3-methylstyrene or 4-methylstyrene or mixtures thereof with monomer having a carbon chain lengths of about 12 carbon atoms or more, a copolymer of 4-t-butyl-styrene with monomer having a carbon chain lengths of about 12 carbon atoms or more, or mixtures thereof.

19. The drag-reducing polymer described in claim 16, wherein from about 5% to about 50% of the total weight of the drag-reducing polymer comprises ultra-high molecular weight hard-polymer.

20. A drag-reducing polymer suspension comprising:
(a) ultra-high molecular weight small-size soft-polymer particles;
(b) ultra-high molecular weight small-size hard-polymer particles; and,
(c) a suspending fluid.
wherein the drag-reducing polymer suspension contains no partitioning agent.

21. The drag-reducing polymer suspension described in claim 20, wherein the ultra-high molecular weight soft-polymer is a poly(alpha-olefin) homopolymer prepared from monomer with carbon chain lengths of about 4 to about 10 carbon atoms, a copolymer prepared from monomers of carbon chain lengths of about 4 to about 12 carbon atoms, or mixtures thereof.

22. The drag-reducing polymer suspension described in claim 20, wherein the ultra-high molecular weight hard-polymer is a poly(alpha-olefin) homopolymer prepared from monomer with carbon chain lengths of about 14 carbon atoms or more, a copolymer prepared from monomer s with a carbon chain lengths of about 12 carbon atoms or more, a copolymer of styrene with monomer having a carbon chain lengths of about 12 carbon atoms or more, a copolymer of 3-methylstyrene or 4-methylstyrene or mixtures thereof with monomer having a carbon chain lengths of about 12 carbon atoms or more, a copolymer of 4-t-butyl-styrene with monomer having a carbon chain lengths of about 12 carbon atoms or more, or mixtures thereof.

23. The drag-reducing polymer suspension described in claim 20, wherein from about 5% to about 50% of the combined weight of the ultra-high molecular weight small-size soft-polymer particles and ultra-high molecular weight small-size hard-polymer particles comprises ultra-high molecular weight hard-polymer.

24. The drag-reducing polymer suspension described in claim 20, wherein the suspending fluid is non-aqueous and is a linear alcohol, a branched alcohol, an alcohol in combination with polyethylene glycol containing up to 14 carbon atoms, di(propylene glycol) methyl ether, tri(propylene glycol) methyl ether, tetra(propylene glycol) methyl ether, ethyl glycol ethers, or mixtures thereof.

25. A method for the preparation of a drag-reducing polymer comprising performing the following steps, in order:
(a) grinding an ultra-high molecular weight hard-polymer and at a temperature below its lowest glass-transition temperature to form small-size hard-polymer particles;
(b) coarse grinding ultra-high molecular weight soft-polymer to form small soft-polymer pieces of less than about 2 cm in diameter;
(c) mixing the small-size hard-polymer particles with the small soft-polymer pieces; and,
(d) grinding small-size hard-polymer particles and small soft-polymer pieces at a temperature below the lowest glass-transition temperature to form the drag-reducing polymer.

26. The method in accordance with claim 25, further comprising after step (d):
mixing the drag reducing polymer with a suspending fluid to form a drag-reducing polymer suspension.
